(19) United States
(12) Patent Application Publication
(10) Pub. No.: US 2009/0189840 A1
(43) Pub. Date: Jul. 30, 2009

(54) DISPLAY APPARATUS AND METHOD FOR DRIVING THE SAME

(76) Inventors: Hong-Sig CHU, Cheonan-si (KR); Jae-Min Ha, Yongin-si (KR); Il-Koo Nah, Yongin-si (KR)

Correspondence Address: F. CHAU & ASSOCIATES, LLC, 130 WOODBURY ROAD, WOODBURY, NY, 11797, US

(21) Appl. No.: 12/172,678

(22) Filed: Jul. 14, 2008

(30) Foreign Application Priority Data
Jan. 25, 2008 (KR) 10-2008-007963

(51) Int. Cl. G09G 3/36; G09G 5/10

(52) U.S. Cl. 345/89; 345/690

(57) ABSTRACT

A display apparatus includes a backlight assembly generating a light; a sensor sensing an amount of the light and color coordinates of the light to generate sensing information; a display panel receiving the light and displaying an image in response to a gray-scale voltage; a gray-scale compensation unit receiving M-bit source data and compensating a gray-scale of the source data in response to the sensing information to generate N-bit first compensation data; and a data driver converting the first compensation data into gray-scale voltage and proving the gray-scale voltage to the display panel.

### CROSS-REFERENCE TO RELATED APPLICATION

This application is based on and claims priority from Korean Patent Application No. 2008-07963 filed on Jan. 25, 2008, the contents of which is incorporated by reference herein.

### BACKGROUND OF THE INVENTION

1. Technical Field

The present disclosure relates to a display apparatus and a method of driving the same. More particularly, the present disclosure relates to a display apparatus that is less expensive to manufacture and a method of driving the display apparatus.

2. Discussion of the Related Art

A liquid crystal display includes a liquid crystal display panel and a backlight assembly. The liquid crystal display panel includes two display substrates and a liquid crystal layer interposed between the two display substrates, and the backlight assembly provides the liquid crystal display panel with light.

The liquid crystal display panel applies an electric field to the liquid crystal layer and controls the electric field in order to adjust an amount of light passing through the liquid crystal layer, thereby displaying a desired image. The backlight assembly includes light sources for emitting light and optical sheets arranged above the light sources to diffuse the light.

As the light sources for the backlight assembly, various light sources that emit white light may be used, such as a cold cathode fluorescent lamp, a flat fluorescent lamp, etc. However, in order to reduce power consumption, a liquid crystal display that employs light emitting diodes (LEDs) as the light sources has been developed.

The LED emitting the white light includes a blue LED chip and a yellow fluorescent substance, and the light emitted from the blue LED chip is changed to the white light while passing through the yellow fluorescent substance. Since a white LED mixes a color of the light emitted from the blue LED with a color of the fluorescent substance to generate the white light, it is difficult to control color coordinates of the light emitted from the white LED.

The color coordinates of the white light appropriate to the backlight assembly is limited to a specific range, only a few white LEDs, which have color coordinates of the white light appropriate to the backlight assembly, can be used in the backlight assembly. As a result, the product cost of the white LED increases, thereby increasing the manufacturing cost of the liquid crystal display.

### SUMMARY OF THE INVENTION

A display apparatus, according to an exemplary embodiment of the present invention, includes a backlight assembly, a sensor, a display panel, a gray-scale compensation unit, and a data driver.

The backlight assembly generates a light, and the sensor senses an amount of the light and color coordinates of the light to generate sensing information. The display panel receives the light and displays an image in response to a gray-scale voltage. The gray-scale compensation unit receives M-bit source data and compensates a gray-scale of the source data in response to the sensing information to generate N-bit first compensation data. M is a constant number equal to or larger than 1 and N is a constant number equal to or larger than 1. The data driver converts the first compensation data into the gray-scale voltage to provide the gray-scale voltage to the display panel.

The gray-scale compensation unit may include a data storing part, a controlling part, a data generating part, and a dithering part. The data storing part stores a plurality of second compensation data generated corresponding to the light amount and the color coordinates of the light emitted from the backlight assembly in each gray-scale of M-bit. The controlling part reads out the second compensation data corresponding to the sensing information and the source data. The data generating part bit-expands the source data using the second compensation data that are read out from the data storing part by the controlling part to output third compensation data. The dithering part bit-contracts the third compensation data and dithers the third compensation data to generate the first compensation data. The second compensation data read-out from the data storing part have difference data values between the source data and the third compensation data, and each of the second compensation data has a number of bits smaller than the third compensation data.

The gray-scale compensation unit may include a data storing part, a controlling part, and a dithering part. The data storing part stores a plurality of third compensation data generated corresponding to the light amount and the color coordinates of the light emitted from the backlight assembly in each gray-scale of M-bit. The controlling part reads out the third compensation data corresponding to the sensing information and the source data. The dithering part dithers the third compensation data read out by the controlling part from the data storing part to generate the first compensation data. The third compensation data that are read-out from the data storing part are obtained by bit-expanding the source data.

The backlight assembly may include a plurality of point light sources each of which includes a light emitting diode that emits a white light.

A method of driving a display apparatus having a display panel that receives a light and displays an image in response to a gray-scale voltage, according to an exemplary embodiment of the present invention, is provided as follows. When color coordinates and a light amount of the light are sensed, sensing information is generated. Then, a gray-scale of M-bit source data is compensated in response to the sensing information to generate N-bit first compensation data. M is a constant number equal to or larger than 1 and N is a constant number equal to or larger than 1. The first compensation data is converted into the gray-scale voltage and the gray-scale voltage is provided to the display panel.

A display apparatus, according to an exemplary embodiment of the present invention, includes a backlight assembly, a sensor, a display panel, a gray-scale compensation unit, and a data driver.

The backlight assembly generates a light, and the display panel receives the light and displays an image in response to a gray-scale voltage. The gray-scale compensation unit receives M-bit source data, stores a plurality of second compensation data generated corresponding to a light amount and color coordinates of the light generated by the backlight assembly in each gray-scale of M-bit, and compensates a gray-scale of the source data using the second compensation data to generate first compensation data. The data driver converts the first compensation data into the gray-scale voltage and provides the gray-scale voltage to the display panel.

A method of driving a display apparatus having a display panel that receives a light and displays an image in response to a gray-scale voltage and a data storing part, according to an exemplary embodiment of the present invention, is provided as follows. When color coordinates and a light amount of the light are sensed, sensing information is generated. Second compensation data generated according to each gray-scale of M-bit is stored in the data storing part in response to the sensing information. When M-bit source data is received, a gray-scale of the source data is compensated using a plurality of pre-stored second compensation data to generate N-bit first compensation data. N is a constant number equal to or larger than 1. The first compensation data is converted into the gray-scale voltage and the gray-scale is provided to the display panel.

According to the above, the gray-scale compensation unit compensates the source data according to the chromaticity levels of the backlight assembly. Thus, the liquid crystal display may display the image having uniform gray-scale without relation of the chromaticity levels of the backlight assembly, thereby improving the image display quality and reducing the manufacturing cost.

### BRIEF DESCRIPTION OF THE DRAWINGS

Exemplary embodiments of the present invention will become readily apparent by reference to the following detailed description when considered in conjunction with the accompanying drawings, wherein:

FIG. 1 is a block diagram showing a liquid crystal display according to an exemplary embodiment of the present invention;

FIG. 2 is a sectional view showing a liquid crystal display panel and a backlight assembly of FIG. 1;

FIG. 3 is a schematic view showing a data storing part of FIG. 1;

FIG. 4 is a flowchart illustrating a driving method of the liquid crystal display of FIG. 1;

FIG. 5 is a flowchart illustrating a data read-out process of second compensation data of FIG. 3;

FIG. 6 is a block diagram showing a liquid crystal display according to an exemplary embodiment of the present invention;

FIG. 7 is a flowchart illustrating a driving method of the liquid crystal display of FIG. 6;

FIG. 8 is a flowchart illustrating a data read-out process of third compensation data of FIG. 7;

FIG. 9 is a block diagram showing a liquid crystal display according to an exemplary embodiment of the present invention; and

FIG. 10 is a flowchart illustrating a driving method of the liquid crystal display of FIG. 9.

### DETAILED DESCRIPTION OF EXEMPLARY EMBODIMENTS

It will be understood that when an element or layer is referred to as being “on”, “connected to” or “coupled to” another element or layer, it can be directly on, connected or coupled to the other element or layer or intervening elements or layers may be present. Like numbers refer to like elements throughout.

Hereinafter, exemplary embodiments of the present invention will be explained in detail with reference to the accompanying drawings.

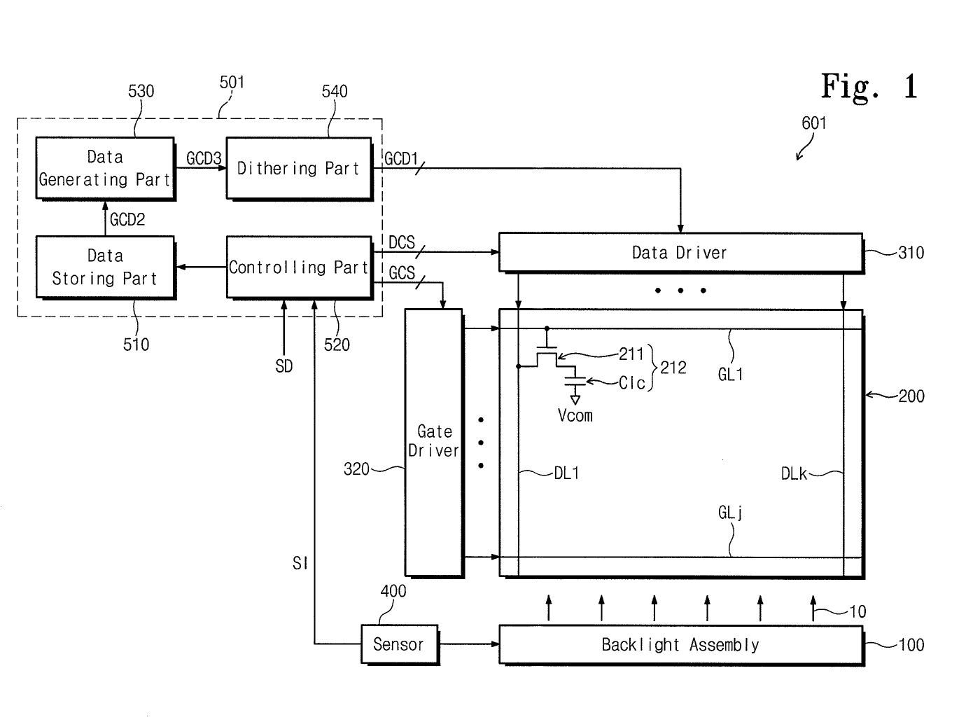

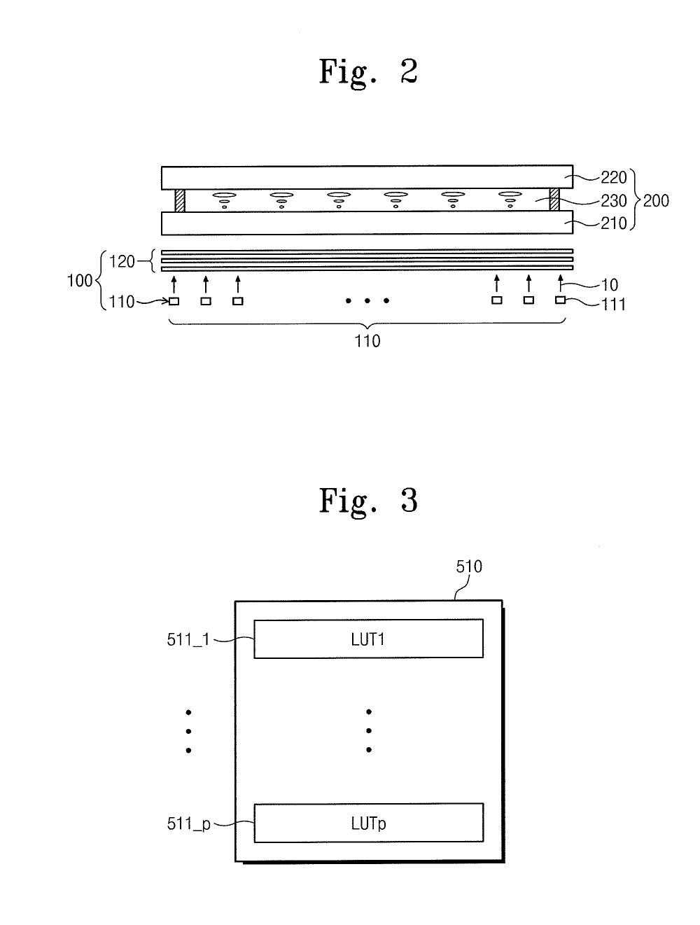

Referring to FIGS. 1 and 2, a liquid crystal display 601 includes a backlight assembly 100, a liquid crystal display panel 200, a data driver 310, a gate driver 320, a sensor 400, and a gray-scale compensation unit 501.

The backlight assembly 100 is disposed under the liquid crystal display panel 200 and generates light 10. The backlight assembly 100 includes a plurality of point light sources 110 and a plurality of optical sheets 120.

Each point light source 111 includes a white light emitting diode (LED). The optical sheets 120 are arranged between the point light sources 110 and the liquid crystal display panel 200 to improve optical characteristics (i.e., brightness) of the light 10 emitted from the point light sources 111.

The liquid crystal display panel 200 includes an array substrate 210, a color filter substrate 220 facing the array substrate 210, and a liquid crystal layer 230 interposed between the array substrate 210 and the color filter substrate 220.

Particularly, the array substrate 210 includes first to j-th gate lines GL1˜GLnj, first to k-th data line DL1˜DLk, and a plurality of pixels.

The first to j-th gate lines GL1˜GLj are extended in a predetermined direction and spaced apart from each other. The first to j-th gate lines GL1˜GLj are electrically connected to the gate driver 320 and transmit gate signals sequentially output from the gate driver 320.

The first to k-th data lines DL1˜DLk are insulated from and intersected with the first to j-th gate lines GL1˜GLj in order to define pixels. The first to k-th data lines DL1˜DLk are electrically connected to the data driver 310 and transmit data signals (for example gray-scale voltages) output from the data driver 310.

The pixels are turned on in response to the gate signal applied through a corresponding gate line of the gate lines GL1˜GLj. Each of the pixels includes a thin film transistor (TFT) and a liquid crystal capacitor. As an example of a representative pixel, a first pixel 212 includes a first thin film transistor 211 and a first liquid crystal capacitor Clc. The first thin film transistor 211 includes a gate electrode connected to the first gate line GL1, a source electrode connected to the first data line DL1, and a drain electrode connected to a first terminal of the liquid crystal capacitor Clc. The liquid crystal capacitor Clc further includes a second terminal to which a common voltage Vcom is applied.

The color filter substrate 220 is arranged above the array substrate 210. The color filter substrate 220 displays colors respectively corresponding to the pixels by using the light passing through the liquid crystal layer 230 and emitting from the backlight assembly 100. Gray-scales of the colors displayed through the pixels are determined by the gray-scale voltages.

The data driver 310 is arranged adjacent to one of the ends of the first to k-th data lines DL1˜DLk, and the gate driver 320 is arranged adjacent to one of the ends of the first to j-th gate lines GL1˜GLj. The data driver 310 outputs the gray-scale voltages to the first to k-th data lines DL1˜DLk in response to data control signals applied from the gray-scale compensation unit 501. The data driver 310 may be mounted on the array substrate 210 or may be separated from the array substrate 210.

The gate driver 320 sequentially outputs the gate signals to the first to j-th gate lines GL1˜GLj in response to gate control signals applied from the gray-scale compensation unit 501. The gate driver 320 may be also mounted on the array substrate 210, or may be separated from the array substrate 210.

The sensor 400 senses the amount of the light 10 emitted from the backlight assembly 100 and the color coordinates of the light 10 and generates sensing information SI. The color coordinates may be determined by the white LED 111. The sensor 400 is electrically connected to the gray-scale compensation unit 501 to provide the sensing information SI to the gray-scale compensation unit 501.

The gray-scale compensation unit 501 receives M-bit source data SD (M is a constant number equal to or larger than 1) corresponding to the image, and the source data SD has a gray-scale value corresponding to one of red, green, and blue colors. The gray-scale compensation unit 501 compensates the gray-scale level of the source data SD in response to the sensing information SI to generate first compensation data GCD1. As an example of the present invention, the gray-scale compensation unit 501 compensates the gray-scale level of the source data SD by using an adaptive color correction (ACC) technique.

The gray-scale compensation unit 501 provides the first compensation data GCD1 to the data driver 310, and the data driver 310 changes the first compensation data GCD1 to the gray-scale voltages and provides the gray-scale voltages to the liquid crystal display panel 200.

The gray-scale compensation unit 501 includes a data storing part 510, a controlling part 520, a data generating part 530, and a dithering part 540.

The data storing part 510 stores second compensation data GCD2 generated corresponding to the amount of light 10 emitted from the backlight assembly 100 and the color coordinates of the light 10 in each gray-scale of M-bit.

The second compensation data GCD2 are generated corresponding to each of the red, green and blue colors in each gray-scale of M-bit, and the second compensation data GCD2 have a difference data value between the source data SD and a third compensation data GCD3 obtained by bit-expanding the source data SD. Each of the second compensation data GCD2 has a number of bits smaller than the third compensation data GCD3, thereby reducing the whole size of the data storing part 510.

Also, since the second compensation data GCD2 are generated corresponding to each of the red, green and blue colors in each gray-scale of M-bit, the gray-scale compensation unit 501 may control the gray-scale voltages according to a color chromaticity of the light 10 provided to the liquid crystal display panel 200.

That is, the color chromaticity of the light 10 emitted from the white LED 111 is determined by the light amount and the color coordinates of the backlight assembly 100. The second compensation data GCD2 are generated corresponding to chromaticity levels in each gray-scale of M-bit after dividing color chromaticity range of the light 10 emitted from the backlight assembly 100. Accordingly, although the second compensation data GCD2 correspond to the same gray-scale, the second compensation data GCD2 may have different values from each other according to the color chromaticity range of the light 10. Hereinafter, the divided color chromaticity range of the light 10 will be referred to as the chromaticity levels.

Referring to FIGS. 1 and 3, the data storing part 510 includes first to p-th look-up tables 511-1˜511-p to store the second compensation data GCD2. The first to p-th look-up tables 511-1˜511-p are generated corresponding to the chromaticity levels in one-to-one fashion, and the number of the look-up tables 511-1˜511-p are the same as the chromaticity levels.

Each of the second compensation data GCD2 is stored in a corresponding look-up table, which has the same chromaticity level, of the look-up tables 511-1˜511-p. The second compensation data GCD2 stored in the look-up table 511-1˜511-p are stored corresponding to the red, green and blue colors in each gray-scale of M-bit.

The second compensation data GCD2 stored in the first to p-th look-up tables 511-1˜511-p are read out by the controlling part 520. The controlling part 520 receives the source data SD and the sensing information SI and reads out the second compensation data GCD2 corresponding to the sensing information SI and the source data SD from the data storing part 510.

Particularly, the controlling part 520 selects a chromaticity level corresponding to the sensing information SI and selects a look-up table of the first to p-th look-up tables 511-1˜511-p, corresponding to the selected chromaticity level. The controlling part 520 reads out the second compensation data GCD2 corresponding to the gray-scale and the color of the source data SD from the selected look-up table and provides the read-out second compensation data GCD2 to the data generating part 530.

Also, the controlling part 520 applies the data control signal DCS and the gate control signal GCS to the data driver 310 and the gate driver 320 in response to the source data SD, respectively.

The data generating part 530 generates the third compensation data GCD3 using the second compensation data GCD2 that are read out from the data storing part 510 and the source data SD, and the data generating part 530 provides the third compensation data GCD3 to the dithering part 540.

The dithering part 540 contracts the number of bits of the third compensation data GCD3 considering the data bits of the data driver 310 and dithers the third compensation data GCD3 to generate the first compensation data GCD1. The dithering part 540 provides the first compensation data GCD1 to the data driver 310, and the data driver 310 converts the first compensation data GCD1 into the gray-scale voltages.

As described above, the gray-scale compensation unit 501 compensates the source data SD according to the chromaticity levels of the light 10 generated by the backlight assembly 100. Thus, the liquid crystal display 601 may display uniform gray-scale without relation of the chromaticity levels of the light emitted from the white LED 111, thereby improving image display quality and reducing manufacturing cost.

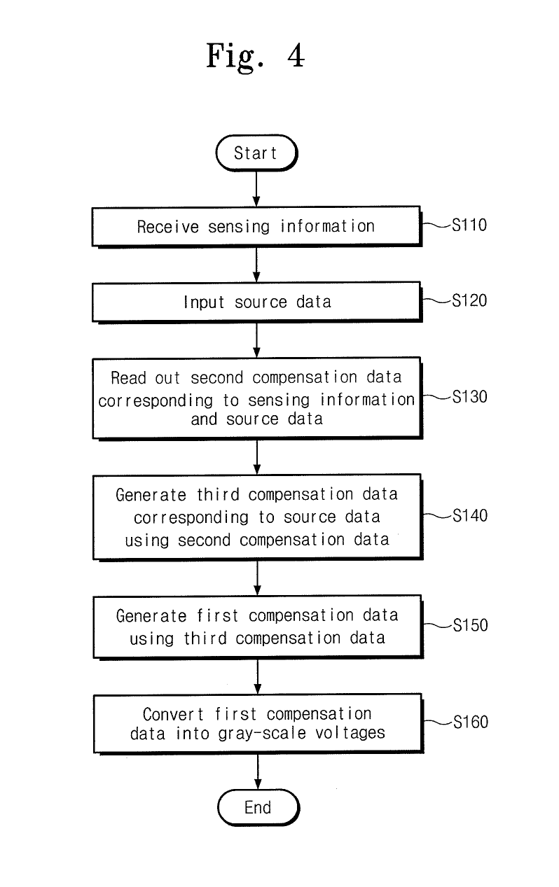

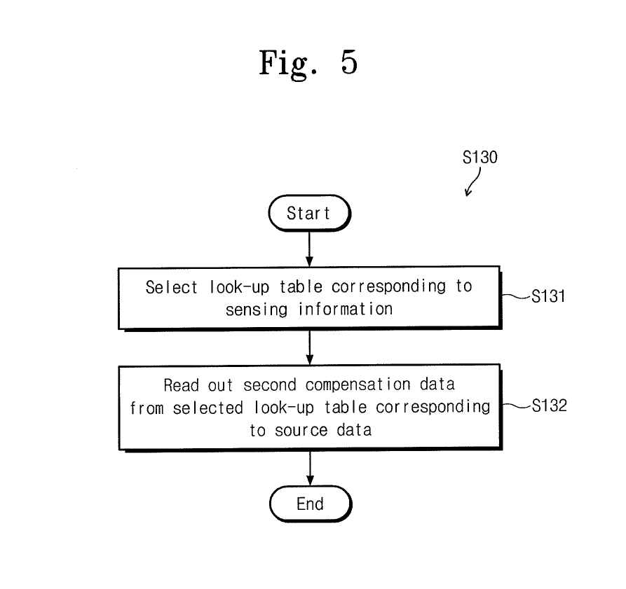

Hereinafter, the compensation process of the source data SD in the gray-scale compensation unit 501 will be described in detail with reference to FIGS. 4 and 5.

Referring to FIGS. 1 and 4, the sensor 400 senses the light amount and the color coordinates of the light generated by the backlight assembly 100 to generate the sensing information SI, and provides the sensing information SI to the controlling part 520 (S110). The sensor 400 generates the sensing information SI every time the drive of the liquid crystal display panel 200 starts, for example.

The controlling part 520 receives the source data SD (S120).

Then, the controlling part 520 reads out the second compensation data GCD2 corresponding to the sensing information SI and the source data SD from the data storing part 510 (S 130).

Referring to FIGS. 1 and 5, the controlling part 520 selects the look-up table, corresponding to the sensing information SI, from among the first to p-th look-up tables 511-1˜511-p (S131).

Next, the controlling part 520 reads out the second compensation data GCD2 from the selected look-up corresponding to the color and gray-scale of the source data SD and provides the read-out second compensation data GCD2 to the data generating part 530 (S133).

Referring to FIGS. 1 and 4 again, the data generating part 530 generates the third compensation data GCD3 using the second compensation data GCD2 and the source data SD and provides the third compensation data GCD3 to the dithering part 540 (S140).

The dithering part 540 dithers the third compensation data GCD3 after bit-contracting the third compensation data GCD3 and provides the first compensation data GCD1 to the data driver 310 (S150)

The data driver 310 converts the first compensation data GCD 1 into the gray-scale voltages and provides the gray-scale voltages to the liquid crystal display panel 200 (S160). As a result, the liquid crystal display panel 200 may display the image corresponding to the chromaticity levels of the light generated by the backlight assembly 100 and the source data SD.

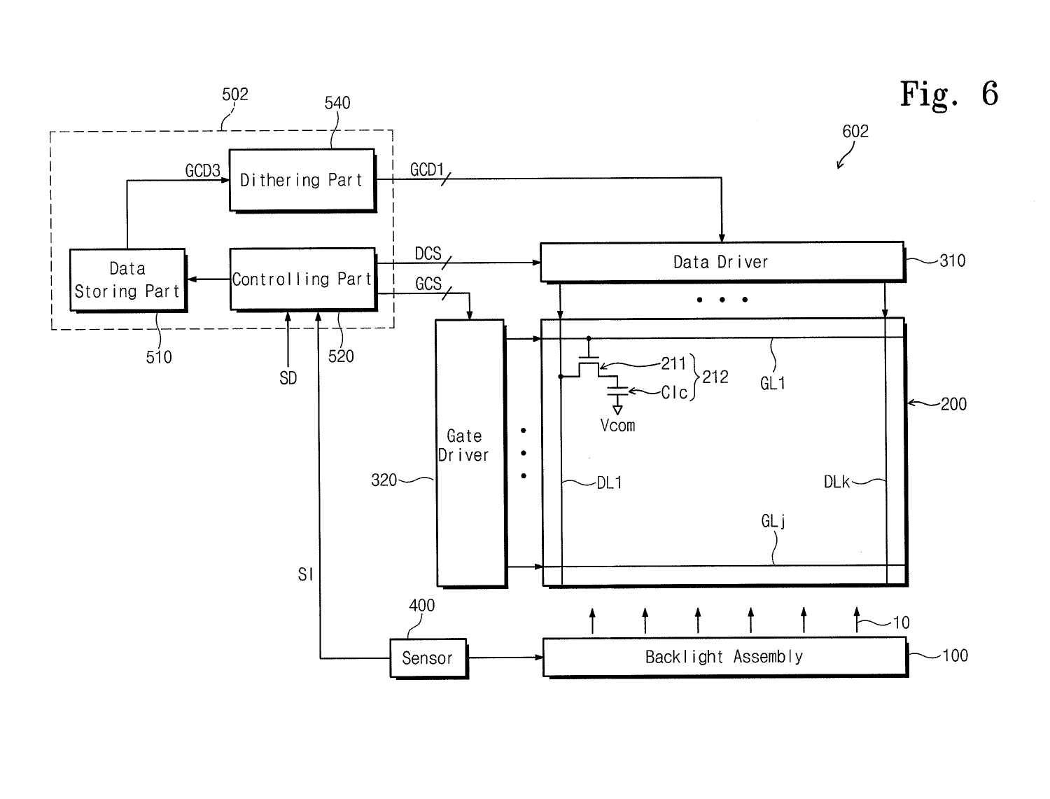

In FIG. 6, a liquid crystal display 602 includes the same configuration and function as those of the liquid crystal display 610 shown in FIG. 1 except for the gray-scale compensation unit 502. In FIG. 6, the same reference numerals denote the same elements in FIG. 1, and thus the detailed descriptions of the same elements will be omitted.

The liquid crystal display 602 includes a backlight assembly 100, a liquid crystal display panel 200, a data driver 310, a gate driver 320, a sensor 400, and a gray-scale compensation unit 502.

The gray-scale compensation unit 502 includes a data storing part 510, a controlling part 520, and a dithering part 540. Since the data driver 510, the controlling part 520, and the dithering part 540 have the same configuration and function as those in FIG. 1, their detailed descriptions will be omitted.

Referring to FIGS. 3 and 6, the data storing part 510 includes first to p-th look-up tables 511-1˜1511-p. Third compensation data GCD3 obtained by bit-expanding M-bit source data SD provided to the controlling part 510 are stored in each of the first to p-th look-up tables 511-1˜511-p. That is, the data storing part 510 stores the third compensation data GCD3 generated corresponding to each of the red, green and blue colors in each gray-scale of M-bit.

The first to p-th look-up tables 511-1˜511-p are generated corresponding to the chromaticity levels in one-to-one fashion, and the number of the look-up tables 511-1˜511-p are the same as the number of the chromaticity levels.

Each of the third compensation data GCD3 is stored in a corresponding look-up table, which has the same chromaticity level, of the look-up tables 511-1˜511-p. The third compensation data GCD3 stored in the first to p-th look-up tables 511-1˜511-p are stored corresponding to the red, green and blue colors in each gray-scale of M-bit.

The third compensation data stored in the first to p-th look-up tables 511-1˜511-p is read out by the controlling part 520. The controlling part 520 receives the source data SD and the sensing information SI and reads out the third compensation data GCD3 corresponding to the source data SD and the sensing information SI. The controlling part 520 provides the read-out third compensation data GCD3 to the dithering part 540.

The dithering part 540 contracts the number of bits of the third compensation data GCD3 considering the data bits of the data driver 310 and dithers the third compensation data GCD3 to generate the first compensation data GCD1. The dithering part 540 provides the first compensation data GCD1 to the data driver 310, and the data driver 310 converts the first compensation data GCD 1 into the gray-scale voltages and provides the gray-scale voltages to the liquid crystal display panel 200.

As described above, since the third compensation data obtained by bit-expanding the M-bit gray-scales levels are stored in the data storing part 520, the gray-scale compensation unit 502 does not need to perform the calculation process for the third compensation data GCD3. Thus, the data-processing speed of the liquid crystal display 602 may be improved.

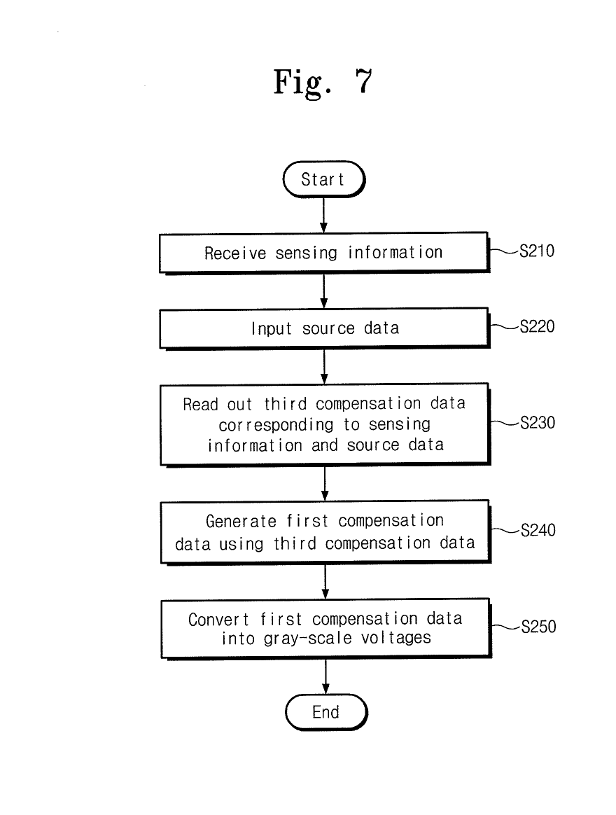

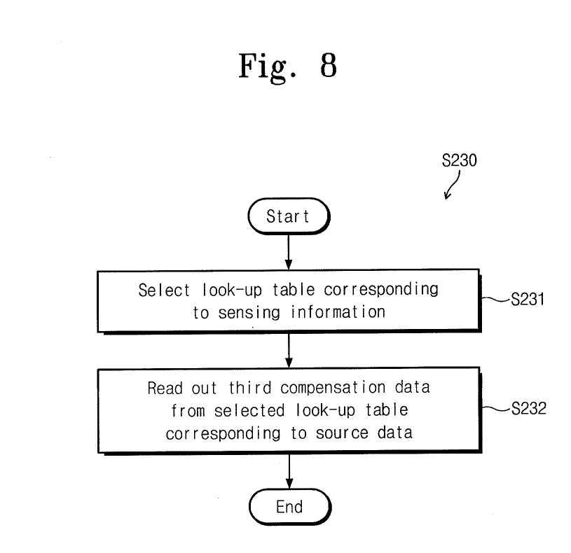

FIG. 7 is a flowchart illustrating a driving method of the liquid crystal display of FIG. 6, and FIG. 8 is a flowchart illustrating a data read-out process of third compensation data of FIG. 7.

Referring to FIGS. 6 and 7, the sensor 400 senses the light amount and the color coordinates of the light generated by the backlight assembly 100 to generate the sensing information SI, and the sensor 400 provides the sensing information SI to the controlling part 520 (S210). The sensor 400 generates the sensing information SI every time the drive of the liquid crystal display panel 200 starts, for example.

The controlling part 520 receives the source data SD (S220).

Then, the controlling part 520 reads out the third compensation data GCD3 corresponding to the sensing information SI and the source data SD from the data storing part 510 (S230).

Referring to FIGS. 7 and 8, the controlling part 520 selects the look-up table, corresponding to the sensing information SI, from among the first to p-th look-up tables 511-1˜511-p (S231).

Next, the controlling part 520 reads out the third compensation data GCD3 from the selected look-up corresponding to the color and gray-scale of the source data SD and provides the read-out third compensation data GCD3 to the dithering part 540 (S233).

Referring to FIGS. 6 and 7 again, the data generating part 530 generates the third compensation data GCD3 using the second compensation data GCD2 and the source data SD and provides the third compensation data GCD3 to the dithering part 540 (S140).

The dithering part 540 dithers the third compensation data GCD3 after bit-contracting the third compensation data GCD3 and provides the first compensation data GCD1 to the data driver 310 (S240)

The data driver 310 converts the first compensation data GCD1 into the gray-scale voltages and provides the gray-scale voltages to the liquid crystal display panel 200 (S250). Accordingly, the liquid crystal display panel 200 may display the image corresponding to the chromaticity levels of the light generated by the backlight assembly 100 and the source data SD.

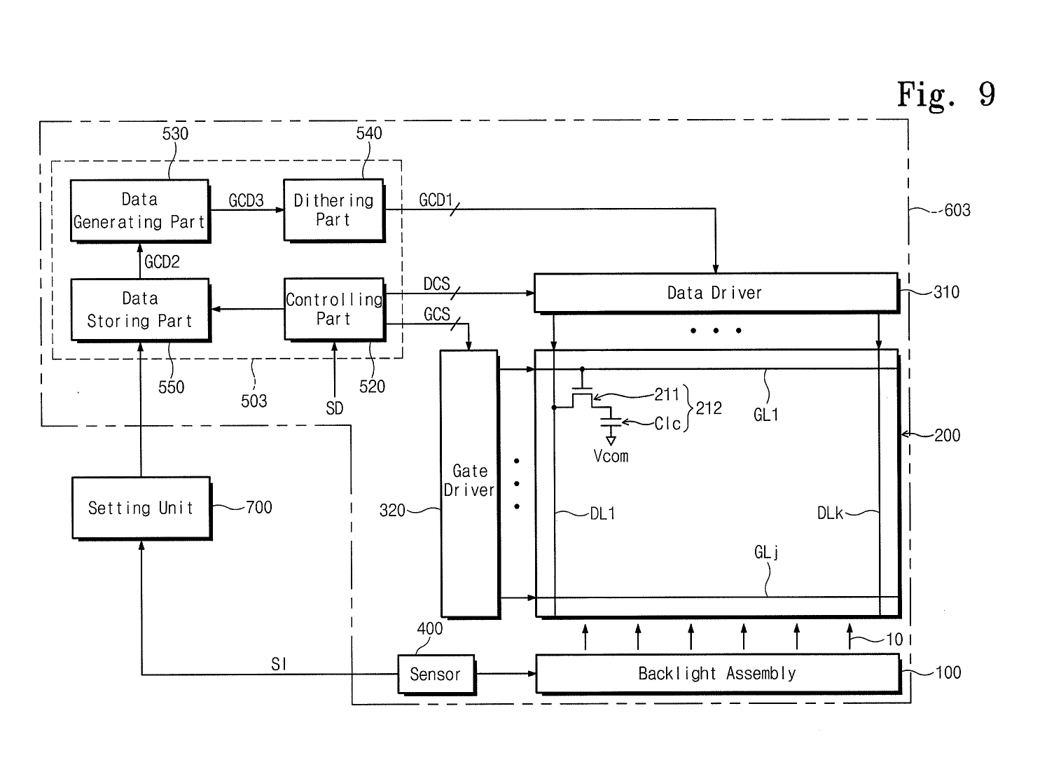

In FIG. 9, the same reference numerals denote the same elements in FIG. 1, and thus the detailed description of the same elements will be omitted.

Referring to FIG. 9, a liquid crystal display 603 includes a backlight assembly 100, a liquid crystal display panel 200, a data driver 310, a gate driver 320, a sensor 400, and a gray-scale compensation unit 503.

The gray-scale compensation unit 503 includes a data storing part 550, a controlling part 520, a data generating part 530, and a dithering part 540. Since the controlling part 520, the data generating part 530, and the dithering part 540 have the same configuration and function as those in FIG. 1, their detailed descriptions will be omitted.

The data storing part 550 stores a plurality of second compensation data GCD2 corresponding to one of the chromaticity levels, and the second compensation data GCD2 are the same as the second compensation data GCD2 shown in FIG. 1. In particular, the second compensation data GCD2 stored in the data storing part 550 are set by an external setting unit 700 while the liquid crystal display 603 is manufactured.

The setting unit 700 stores the second compensation data GCD2 generated corresponding to the chromaticity levels in each gray-scale of M-bit. The setting unit 700 includes a plurality of look-up tables in which the second compensation data are stored, and the look-up tables of the setting unit 700 are the same as the first to p-th look-up tables 511-1˜511-p of the data storing part 510 shown in FIG. 3.

When the liquid crystal display 603 is initially set, the setting unit 700 receives sensing information SI corresponding to the backlight assembly 100 from the sensor 400. The setting unit 700 receives the sensing information SI from the sensor 400, but may receive the sensing information SI through the controlling part 520.

The setting unit 700 selects a look-up table corresponding to the sensing information SI and stores the selected look-up table in the data storing part 550. Thus, the data storing part 550 stores only one look-up table, so the data storing part 550 stores the second compensation data corresponding to an initial chromaticity level of the backlight assembly 100.

Similarly to the gray-scale compensation unit 501 shown in FIG. 1, the gray-scale compensation unit 503 includes the data generating part 530, but the data generating part 530 may be removed from the gray-scale compensation unit 503. In this case, the setting unit 700 stores a plurality of third compensation data GCD3 generated corresponding to each chromaticity level in each gray-scale of M-bit, and the third compensation data GCD3 are the same as the third compensation data GCD3 shown in FIG. 6. Accordingly, the look-up table of the data compensation part 550 stores the third compensation data GCD3 corresponding to the initial chromaticity level of the backlight assembly 100.

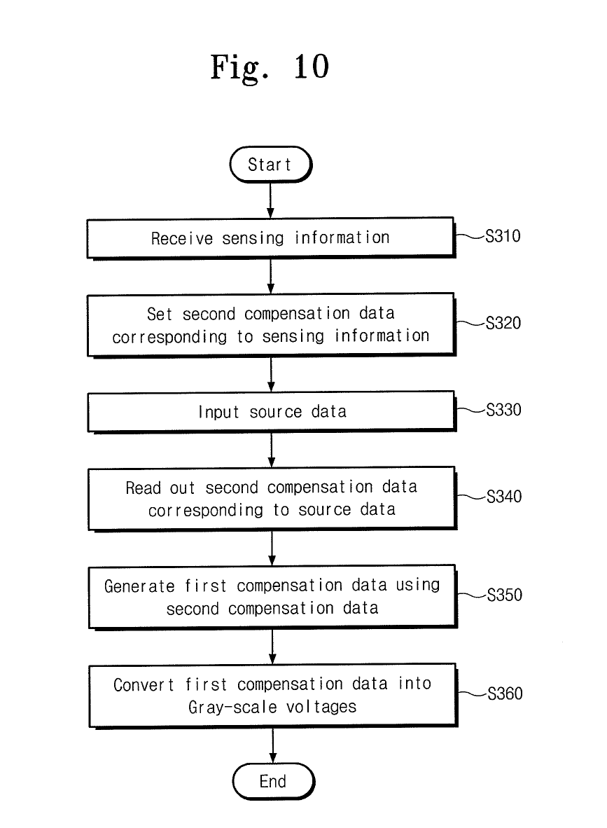

FIG. 10 is a flowchart illustrating a driving method of the liquid crystal display of FIG. 9.

Referring to FIGS. 9 and 10, the setting unit 700 receives the sensing information SI from the sensor 400 (S310) and reads out the second compensation data corresponding to the sensing information SI among pre-stored second compensation data in order to store the read-out second compensation data in the data storing part 550 (S320). Thus, the data setting process for gray-scale compensation of the liquid crystal display 603 is completed when manufacturing the liquid crystal display 603

The read-out process of the second compensation data corresponding to the sensing information SI is as follows. The look-up table corresponding to the sensing information SI (i.e., the initial chromaticity level of the backlight assembly 100) is selected from the look-up tables that are pre-stored in the setting unit 700. Then, the setting unit 700 stores the selected look-up table in the data storing part 550, so that the second compensation data corresponding to the initial chromaticity level of the backlight assembly 100 may be stored in the data storing part 550.

When the initial setting process of the liquid crystal display 603 is completed, the controlling part 520 receives source data SD (S330), reads out the second compensation data GCD2 corresponding to the source data SD from the data storing part 550, and provides the read-out second compensation data GCD2 to the data generating part 530 (S340).

The data generating part 530 and the dithering part 540 generate the first compensation data GCD1 using the second compensation data GCD2 (S350). The processes of generating the first compensation data GCD1 using the second compensation data GCD2 are the same as those of FIG. 4, and thus the detailed descriptions thereof will be omitted.

The data driver 310 converts the first compensation data GCD1 from the dithering part 540 into the gray-scale voltages and provides the gray-scale voltages to the liquid crystal display panel 200 (S360).

The data storing part 550 stores the second compensation data corresponding to the sensing information SI, however the data storing part 550 may store the third compensation data corresponding to the sensing information SI. In this case, the controlling part 520 reads out the third compensation data GCD3 corresponding to the source data SD from the data storing part 550 and provides the read-out third compensation data GCD3 to the dithering part 540. The dithering part 540 generates the first compensation data GCD3 using the third compensation data GCD3.

According to the above, the gray-scale compensation unit compensates the source data according to the chromaticity levels of the backlight assembly. Thus, the liquid crystal display may display the image having uniform gray-scale without relation of the chromaticity levels of the backlight assembly, thereby improving the image display quality and reducing the manufacturing cost.

Although exemplary embodiments of the present invention have been described, it is understood that the present invention should not be limited to these exemplary embodiments but various changes and modifications can be made by one ordinary skilled in the art within the spirit and scope of the disclosure.

What is claimed is:

1. A display apparatus comprising:
a backlight assembly generating a light;
a sensor sensing an amount of the light and color coordinates of the light to generate sensing information;
a display panel receiving the light and displaying an image in response to a gray-scale voltage;
a gray-scale compensation unit receiving M-bit source data and compensating a gray-scale of the source data in response to the sensing information to generate N-bit first compensation data, where M is a constant number equal to or larger than 1 and N is a constant number equal to or larger than 1; and
a data driver converting the first compensation data into the gray-scale voltage and providing the gray-scale voltage to the display panel.

2. The display apparatus of claim 1, wherein the gray-scale compensation unit comprises:
a data storing part storing a plurality of second compensation data generated corresponding to the light amount and the color coordinates of the light emitted from the backlight assembly in each gray-scale of M-bit;
a controlling part reading out the second compensation data corresponding to the sensing information and the source data;
a data generating part bit-expanding the source data using the second compensation data that are read out from the data storing part by the controlling part to output third compensation data; and
a dithering part bit-contracting the third compensation data and dithering the third compensation data to generate the first compensation data, and
wherein the second compensation data read-out from the data storing part have difference data values between the source data and the third compensation data, and each of the second compensation data has a number of bits smaller than the third compensation data.

3. The display apparatus of claim 2, wherein the source data comprises gray-scale data corresponding to one of red, green, and blue colors, the data storing part stores a plurality of look-up tables for storing the second compensation data, the look-up tables are generated corresponding to the light amount and the color coordinates of the backlight assembly, the second compensation data generated corresponding to the light amount and the color coordinates of the backlight assembly corresponding to the look-up tables are stored in the look-up tables corresponding to each of the red, green and blue colors in each gray-scale of M-bit, and the controlling part reads out the second compensation data corresponding to the gray-scale and color of the source data from the look-up table corresponding to the sensing information and provides the read-out second compensation data to the data generating part.

4. The display apparatus of claim 1, wherein the gray-scale compensation unit comprises:
a data storing part storing a plurality of third compensation data generated corresponding to the light amount and the color coordinates of the light emitted from the backlight assembly in each gray-scale of M-bit;
a controlling part reading out the third compensation data corresponding to the sensing information and the source data;
a dithering part dithering the third compensation data read out by the controlling part from the data storing part to generate the first compensation data, and
wherein the third compensation data read-out from the data storing part are obtained by bit-expanding the source data.

5. The display apparatus of claim 4, wherein the source data comprises gray-scale data corresponding to one of red, green, and blue colors, the data storing part stores a plurality of look-up tables for storing the third compensation data, the look-up tables are generated corresponding to the light amount and the color coordinates of the backlight assembly, the third compensation data generated corresponding to the light amount and the color coordinates of the backlight assembly corresponding to the look-up tables are stored in the look-up tables corresponding to each of the red, green and blue colors in each gray-scale of M-bit, and the controlling part reads out the third compensation data corresponding to the gray-scale and color of the source data from the look-up table corresponding to the sensing information and provides the read-out third compensation data to the data generating part.

6. The display apparatus of claim 1, wherein the backlight assembly comprises a plurality of point light sources each of which comprises a light emitting diode that emits a white light.

7. A method of driving a display apparatus having a display panel that receives a light and displays an image in response to a gray-scale voltage, comprising:
sensing color coordinates and a light amount of the light to generate sensing information;
compensating a gray-scale of M-bit source data in response to the sensing information to generate N-bit first compensation data, where M is a constant number equal to or larger than 1 and N is a constant number equal to or larger than 1; and
converting the first compensation data into the gray-scale voltage to provide the gray-scale voltage to the display panel.

8. The method of claim 7, wherein the generating of the first compensation data comprises:
reading out second compensation data corresponding to the sensing information and the source data from a plurality of second compensation data pre-stored in response to the light amount and the color coordinates of the light emitted from the backlight assembly in each gray-scale of M-bit;
bit-expanding the source data using the read-out second compensation data to generate third compensation data; and
bit-contracting and dithering the third compensation data to generate the first compensation data, and
wherein the read-out second compensation data have difference data values between the source data and the third compensation data, and each of the second compensation data has a number of bits smaller than the third compensation data.

9. The method of claim 8, wherein the source data comprises gray-scale data corresponding to one of red, green, and blue colors, the second compensation data are stored in a plurality of look-up tables, the look-up tables are generated corresponding to the light amount and the color coordinates of the backlight assembly, and the second compensation data generated corresponding to the light amount and the color coordinates of the backlight assembly corresponding to the look-up tables are stored in the look-up tables corresponding to each of the red, green and blue colors in each gray-scale of M-bit.

10. The method of claim 9, wherein the reading out of the second compensation data comprises:
selecting a look-up table, corresponding to the sensing information, from the plurality of look-up tables; and
reading out the second compensation data corresponding to the gray-scale and color of the source data from the selected look-up table.

11. The method of claim 7, wherein the generating of the first compensation data comprises:
reading out third compensation data corresponding to the sensing information and the source data from a plurality of third compensation data pre-stored in response to the light amount and the color coordinates of the light emitted from the backlight assembly in each gray-scale of M-bit; and
bit-contracting and dithering the third compensation data to generate the first compensation data, and
wherein the read-out third compensation data are obtained by bit-expanding the source data.

12. The method of claim 11, wherein the source data comprises gray-scale data corresponding to one of red, green, and blue colors, the third compensation data are stored in a plurality of look-up tables, the look-up tables are generated corresponding to the light amount and the color coordinates of the backlight assembly, and the third compensation data generated corresponding to the light amount and the color coordinates of the backlight assembly corresponding to the look-up tables are stored in the look-up tables corresponding to each of the red, green and blue colors in each gray-scale of M-bit.

13. The method of claim 12, wherein the reading out of the third compensation data comprises:
selecting a look-up table corresponding to the sensing information from the plurality of look-up tables; and
reading out the third compensation data corresponding to the gray-scale and color of the source data from the selected look-up table.

14. The method of claim 7, wherein the sensing information is generated every time the drive of the display panel is started.

15. A display apparatus comprising:
a backlight assembly generating a light;
a display panel receiving the light and displaying an image in response to a gray-scale voltage;
a gray-scale compensation unit receiving M-bit source data, storing a plurality of second compensation data generated corresponding to a light amount and color coordinates of the light generated by the backlight assembly in each gray-scale of M-bit, and compensating a gray-scale of the source data using the second compensation data to generate first compensation data; and
a data driver converting the first compensation data into the gray-scale voltage and providing the gray-scale voltage to the display panel.

16. The display apparatus of claim 15, wherein the gray-scale compensation unit comprises:
a data storing part storing the second compensation data;
a controlling part reading out the second compensation data corresponding to the source data;
a data generating part bit-expanding the source data using the second compensation data that are read out from the data storing part to output third compensation data; and
a dithering part bit-contracting the third compensation data and dithering the third compensation data to generate the first compensation data, and
wherein the second compensation data read-out from the data storing part have difference data values between the source data and the third compensation data, and each of the second compensation data has a number of bits smaller than the third compensation data.

17. The display apparatus of claim 15, wherein the gray-scale compensation unit comprises:
a data storing part storing the second compensation data;
a controlling part reading out the second compensation data corresponding to the source data from the data storing part;
a dithering part dithering the second compensation data that are read out from the from the data storing part to generate the first compensation data, and
wherein the second compensation data read-out from the data storing part are obtained by bit-expanding the source data.

18. The display apparatus of claim 15, wherein the source data comprises gray-scale data corresponding to one of red, green, and blue colors, the data storing part stores a look-up table in which the second compensation data are stored, and the second compensation data are stored in the look-up table corresponding to each of the red, green and blue colors in each gray-scale of M-bit.

19. A method of driving a display apparatus having a display panel that receives a light and displays an image in response to a gray-scale voltage and a data storing part, comprising:
sensing color coordinates and a light amount of the light to generate a sensing information;
storing second compensation data generated according to each gray-scale of M-bit in the data storing part in response to the sensing information;
receiving M-bit source data;
compensating a gray-scale of the source data using a plurality of pre-stored second compensation data to generate N-bit first compensation data, where N is a constant number equal to or larger than 1; and
converting the first compensation data into the gray-scale voltage to output the gray-scale voltage to the display panel.

20. The method of claim 19, wherein the generating of the first compensation data comprises:
reading out the second compensation data corresponding to the source data from the data storing part;
bit-expanding the source data using the read-out second compensation data to generate third compensation data; and
bit-contracting and dithering the third compensation data to generate the first compensation data, and
wherein the read-out second compensation data have difference data values between the source data and the third compensation data, and each of the second compensation data has a number of bits smaller than the third compensation data.

21. The method of claim 19, wherein the generating of the first compensation data comprises:
reading out the second compensation data corresponding to the sensing information and the source data from among the second compensation data; and
bit-contracting and dithering the read-out second compensation data to generate the first compensation data, and
wherein the read-out second compensation data is obtained by bit-expanding the source data.

22. The method of claim 19, wherein the source data comprises gray-scale data corresponding to one of red, green, and blue colors, the data storing part stores a look-up table in which the second compensation data are stored, and the second compensation data are stored in the look-up table corresponding to each of the red, green and blue colors in each gray-scale of M-bit.
